(19) United States
(12) Patent Application Publication
(10) Pub. No.: US 2007/0189824 A1
(43) Pub. Date: Aug. 16, 2007

(54) Image formation apparatus

(75) Inventors: Takao Furuya, Kanagawa (JP); Yoshinari Iwaki, Kanagawa (JP); Miho Uno, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/525,809

(22) Filed: Sep. 25, 2006

(30) Foreign Application Priority Data
Feb. 16, 2006 (JP) P2006-039452

(51) Int. Cl. G03G 15/00

(52) U.S. Cl. 399/405

(57) ABSTRACT

An image formation apparatus includes: a toner image formation section that forms a toner image on a recording medium; a fixing device that fixes the toner image; a first roller provided downstream from the fixing device in a transport direction of the recording medium, the first roller coming in contact with a first side of the recording medium and transporting the recording medium; and a second roller abutting the first roller, the second roller coming in contact with a second side of the recording medium opposite to the first side and transporting the recording medium. The solubility parameter on a surface of the first roller is different from the solubility parameter on a surface of the second roller.

### BACKGROUND

This invention relates to an image formation apparatus of a copier, a facsimile, a printer, etc.

### SUMMARY

According to an aspect of the present invention, there is provided an image formation apparatus including: a toner image formation section that forms a toner image on a recording medium; a fixing device that fixes the toner image; a first roller provided downstream from the fixing device in a transport direction of the recording medium, the first roller coming in contact with a first side of the recording medium and transporting the recording medium; and a second roller abutting the first roller, the second roller coming in contact with a second side of the recording medium opposite to the first side and transporting the recording medium, wherein a solubility parameter on a surface of the first roller is different from a solubility parameter on a surface of the second roller.

### BRIEF DESCRIPTION OF THE DRAWINGS

Exemplary embodiments of the present invention will be described in detail based on the following figures, wherein:

FIG. 1 is a sectional view to show the configuration of an image formation apparatus according to a first exemplary embodiment of the invention;

FIG. 2 is a schematic representation to show a transportation device used in the first exemplary embodiment of the invention;

FIG. 3 is a graph to show time change of the outer diameter of each transport roller when transport rolls made of materials different in solubility parameter are immersed in paraffin;

FIG. 4 is a graph to show the relationship between the solubility parameter of each transport roller and the outer diameter change amount of the transport roller when the transport rolls made of materials different in solubility parameter are immersed in paraffin for a time;

FIG. 5A is a graph to show the relationship between the number of transported sheets using a transport roller used in a second exemplary embodiment of the invention and the outer diameter change amount of the transport roller, and FIG. 5B is a graph to show the relationship between the number of sheets transported using the transport roller used in the second exemplary embodiment of the invention and the sheet transport speed of the transport roller;

FIG. 6 is a schematic representation to show a transportation device used in a third exemplary embodiment of the invention; and

FIG. 7A is a graph to show the relationship between the number of transported sheets using a transport roller used in a fourth exemplary embodiment of the invention and the outer diameter change amount of the transport roller, and FIG. 7B is a graph to show the relationship between the number of sheets transported using the transport roller used in the fourth exemplary embodiment of the invention and the sheet transport speed of the transport roller.

### DETAILED DESCRIPTION

Referring now to the accompanying drawings, there are shown exemplary embodiments of the invention.

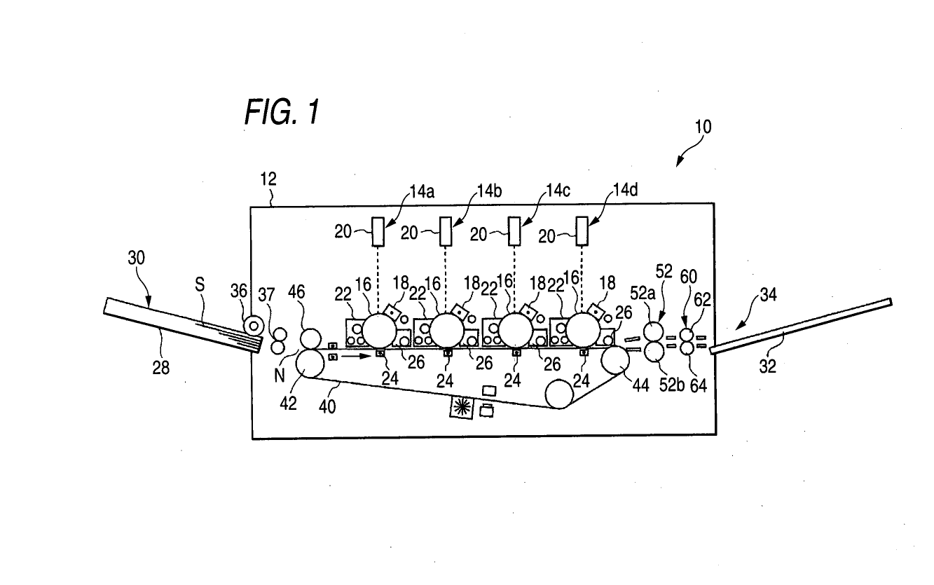

FIG. 1 shows an image formation apparatus 10 according to a first exemplary embodiment of the invention. In FIG. 1, the image formation apparatus 10 has an image formation apparatus main unit 12 containing four image formation sections of a yellow image formation section 14a, a magenta image formation section 14b, a cyan image formation section 14c, and a black image formation section 14d used as toner image formation sections, a fixing device 52 for fixing the toner images formed by the image formation sections onto a sheet, and a transportation device 60 for transporting the sheet with the toner images fixed thereon by the fixing device 52 to the outside of the image formation apparatus main unit 12.

Each of the image formation sections 14a, 14b, 14c, and 14d has a photoconductor 16 used as an image support. Placed in the surroundings of the photoconductor 16 are a charging device 18 for charging the photoconductor 16, a latent image formation device 20 for applying laser light to the surface of the photoconductor 16 charged by the charging device 18 to form a latent image, a developing device 22 for developing the latent image formed by the latent image formation device 20 in a developer, a transfer device 24 for transferring the developed image formed on the surface of the photoconductor 16 by the developing device 22 to a sheet, and a cleaner 26 for removing the remaining developer on the surface of the photoconductor 16 after transfer executed by the transfer device 24.

The developing device 22 stores any toner of yellow, magenta, cyan, or black in response to the image formation section 14a, 14b, 14c, 14d. The toners are manufactured by an emulsion aggregation process (EA process), for example. The toners contain wax used as a low-melting-point material. The wax is an auxiliary additive used to prevent the toner from being deposited on a heating roller 52a (described later) and used to prevent a sheet from being wound around the heating roller 52a; in the exemplary embodiment, paraffin is used.

A solubility parameter of the paraffin is 8.0 (Cal/cm³)^{1/2}. The solubility parameter can be found in various manners; for example, it can be found according to a method described in “R. F. Fedors, Polymer. Eng., 14, (2) 147 (1974)”, which is herein incorporated by reference. The solubility parameter is a value indicating the polarity of material. The larger the absolute value of the solubility parameter difference between two materials, the harder to solve the two materials; the smaller the absolute value of the solubility parameter difference between two materials, the easier to solve the two materials.

As the toner manufacturing method, a solution suspension process or a suspension polymerization process can be used in place of the EA process. The toners may be manufactured using the solution suspension method and a polyester polymerization method in combination.

As the wax, for example, low molecular weight polyolefin wax, silicone wax, fatty amide wax, vegetable wax, animal wax, mineral wax, petroleum wax, or the like may be used in place of paraffin. The solubility parameter of every wax is about 8.0.

A sheet supply section 30 including a sheet supply cassette 28 for storing sheets of ordinary paper, etc., for example, used as recording media is placed upstream of the image formation apparatus main unit 12 (the left in FIG. 1). The sheet supply section 30 has a transport roller 36 for transporting the sheets stored in sheet supply cassette 28 one at a time. An ejection section 34 including an ejection tray 32 is placed downstream of the image formation apparatus main unit 12 (the right in FIG. 1).

A transport belt 40 for transporting a sheet is placed below the image formation sections 14a, 14b, 14c, and 14d. The transport belt 40 is supported on an upstream support roller 42 and a downstream support roller 44 and circulates in the arrow direction for transporting a sheet to the image formation sections 14a, 14b, 14c, and 14d in order. A registration roller 37 is placed between the upstream support roller 42 and the transport roller 36. The registration roller 37 starts to rotate at a timing, whereby a sheet is supplied to the transport belt 40.

The fixing device 52 is placed between the downstream support roller 44 and the ejection tray 32 and has the above-mentioned heating roller 52a containing a heater of a halogen lamp, for example, and a pressurization roller 52b for being pressed against the heating roller 52a. The fixing device 52 heats and pressurizes the toner images formed on a sheet in the image formation sections 14a, 14b, 14c, and 14d, thereby fixing the toner images onto the sheet. The transportation device 60 having a transport roller 62 and a transport roller 64 for being pressed against the transport roller 62 from below in the gravity direction is placed between the fixing device 52 and the ejection section 34.

In the background art, the outer diameter of the transport roller may become large with an increase in the number of sheets transported with the transportation device, causing a failure to occur in transport of the sheet. Then, in the exemplary embodiment, the configuration of the transportation device 60 is designed for better transporting sheets.

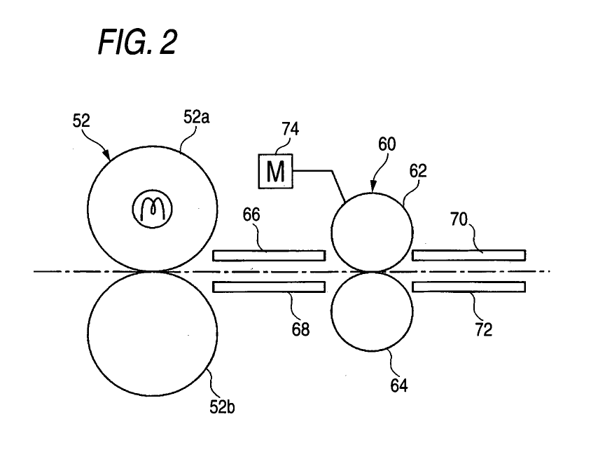

FIG. 2 shows the transportation device 60.

The transportation device 60 has an upper guide plate 66 and a lower guide plate 68 for guiding a sheet with toner images fixed thereon by the fixing device 52, and the transport roller 62 and the transport roller 64 are provided downstream from the upper guide plate 66 and the lower guide plate 68 in the sheet transport direction. An upper guide plate 70 and a lower guide plate 72 for guiding the sheet into the ejection section 34 are provided downstream from the transport roller 62 and the transport roller 64 in the sheet transport direction.

The transport roller 62 is used as a toner image-side transport roller for coming in contact with the side of the sheet on which the toner images are fixed (upward side in FIG. 2) and transporting the sheet. The transport roller 62 is connected to a drive source 74 of a motor, for example, and is used as a drive transport roller for driving and transporting the sheet upon reception of drive transmission from the drive source 74.

Urethane rubber is used as a material of the surface of the transport roller 62. The transport roller 62 needs only to have the surface made of urethane rubber; for example, the surface of a cored bar made of metal is coated with urethane rubber. The solubility parameter of urethane rubber is 10.0 and urethane rubber has high strength and high elasticity and is excellent in abrasion resistance, oil resistance, ozone resistance, and age resistance. On the other hand, urethane rubber has a friction coefficient of about 0.5 to 1.0 and the value is comparatively low among rubber materials.

The transport roller 64 is provided abutting the transport roller 62 and comes in contact with the side opposite to the side of the sheet on which the toner images are fixed (downward side in FIG. 2) for transporting the sheet. The transport roller 64 abuts the transport roller 62 and is driven by the transport roller 62 for transporting the sheet.

Ethylene-propylene-diene rubber (EPDM) is used as a material of the surface of the transport roller 64. The transport roller 64 needs only to have the surface made of EPDM; for example, a cored bar is coated with EPDM. The solubility parameter of EPDM is 8.0 and EPDM is excellent in ozone resistance and heat resistance. EPDM has a friction coefficient of about 1.5 to 2.0 and the value is high among rubber materials and therefore EPDM is suited as a material of the transport roller.

Hitherto, both the transport roller 62 and the transport roller 64 have been implemented as rolls with the surfaces made of EPDM. At the time, as described above, the outer diameter of the upper transport roller 62 may become large, causing a failure to occur in transport of the sheet. At the time, although the outer diameter of the upper transport roller 62 becomes large, the outer diameter of the lower transport roller 64 does not become large. Then, the inventors focused attention on the fact that only the upper transport roller 62 comes in contact with the image formation side of the sheet and that the toner used for image formation contains wax, and conducted an experiment for checking the effect of the wax contained in the toner on the transport roller.

In the experiment, three transport rolls made of EPDM, three transport rolls made of isoprene rubber (IR), three transport rolls made of butyl rubber (IIR), three transport rolls made of butadiene rubber (BR), three transport rolls made of styrene rubber (SBR), three transport rolls made of silicone rubber, three transport rolls made of chloroprene rubber (CR), three transport rolls made of nitrile-butadiene rubber (NBR), and three transport rolls made of urethane rubber were provided and were immersed in the same wax as the wax contained in the toner and change in the outer diameters of the transport rolls was measured.

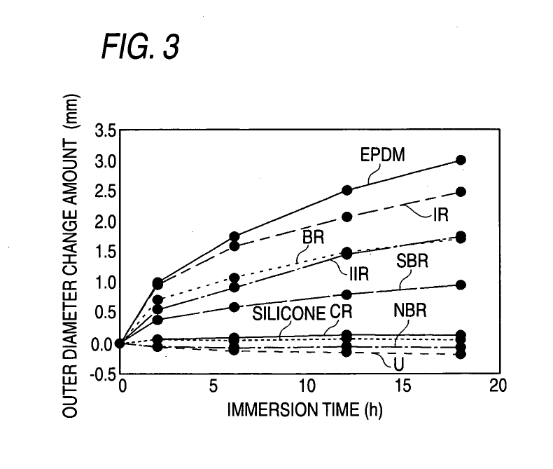

FIG. 3 is a graph to show the relationship between the immersion time and the average value of the outer diameter change amounts (mm) of the transport rolls made of each material. As shown in FIG. 3, it turned out from the experiment that there are transport rolls with the outer diameter made larger like the transport rolls made of EPDM; while, there are transport rolls with the outer diameter scarcely changing like the transport rolls made of urethane rubber. Then, the inventor et al. considered that penetrating of wax in the transport roller may cause the outer diameter of the transport roller to become large, and created a graph to show the relationship between the solubility parameter of a value indicating the polarity of each material and the outer diameter change amount when the transport rolls made of each material were immersed in wax for 18 hours.

As the solubility parameters of the materials of the transport rolls used in the experiment, EPDM is 8.0 and urethane rubber is 10.0 as described above. IR is 8.09, IIR is 7.85, BR is 8.39, SBR is 8.45, silicone rubber is 7.45, CR is 8.71, and NBR is 9.31.

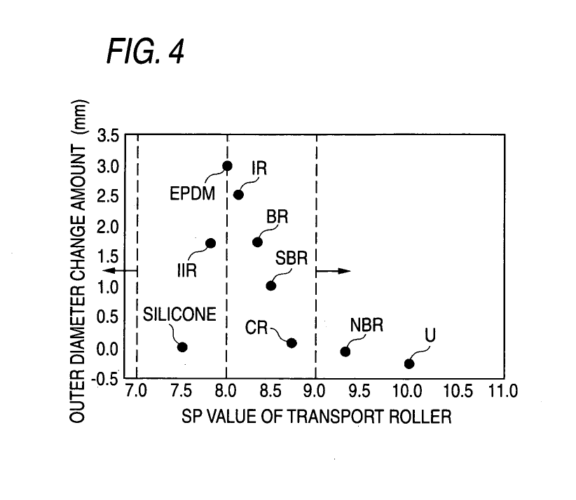

FIG. 4 is a graph to show the relationship between the solubility parameter of the material of each transport roller and the outer diameter change amount when the transport rolls made of each material were immersed in wax for 18 hours. It turned out from the graph that the transport roller made of a material with the solubility parameter closer to 8.0, the solubility parameter of wax, involves the larger outer diameter change amount and that the transport roller made of a material with the solubility parameter more distant from the solubility parameter of wax involves the smaller outer diameter change amount. That is, the inventor et al. found out that the transport roller made of a material with the solubility parameter close to that of wax and easy to dissolve with wax has the outer diameter easy to become large because the wax contained in the toner penetrates with an increase in the number of transported sheets; whereas, the transport roller made of a material with the solubility parameter distant from that of wax and hard to dissolve with wax has the outer diameter hard to become large because the wax contained in the toner is hard to penetrate. The difference between the solubility parameter of the transport roller and wax is preferably 1.0 or more in absolute value.

Then, in the exemplary embodiment, urethane rubber is used as the surface of the transport roller 62 and EPDM is used as the surface of the transport roller 64 as described above for making the solubility parameter on the surface of the transport roller 62 different from the solubility parameter on the surface of the transport roller 64, thereby making it possible to use the transport roller having the optimum characteristic in response to the position as each transport roller. That is, the transport roller 62 is placed at a position where it comes in contact with the fixed toner image and wax is easy to penetrate and thus urethane rubber of a material having the solubility parameter for making the wax contained in the toner hard to penetrate is used as the material of the surface. On the other hand, the transport roller 64 is placed at a position where penetration of wax need not be considered and thus EPDM having a comparatively high friction coefficient and capable of giving a sufficient transport force to a sheet although it has the solubility parameter for making wax easy to penetrate as compared with that of urethane rubber is used as the material of the surface.

Since the transport roller 62 is used as a drive roller and is driven at a given angular velocity by the drive source 74, if expansion occurs, a sheet may be transported at higher speed than the target speed, causing a sheet transport fault to occur. In the exemplary embodiment, however, the solubility parameter on the surface of the transport roller 62 is made different from the solubility parameter on the surface of the transport roller 64 as described above and urethane rubber which scarcely expands is used as the material of the surface of the transport roller 62, so that a sheet transport fault is hard to occur.

Urethane rubber is used as the material of the surface of the transport roller 62 and EPDM is used as the surface of the transport roller 64, whereby the absolute value of the difference between the solubility parameter of the material used as the surface of the transport roller 62 and the solubility parameter of wax is made larger than the absolute value of the difference between the solubility parameter of the material used as the surface of the transport roller 64 and the solubility parameter of wax. That is, letting the solubility parameter on the surface of the transport roller 62 be SP₆₂, the solubility parameter on the surface of the transport roller 64 be SP₆₄, and the solubility parameter of wax be SP_{WAX},

|SP_{WAX}−SP₆₂|>|SP_{WAX}−SP₆₄|

Thus, as compared with the transport roller 64, a material hard to expand can be used as the surface of the transport roller 62 and a sheet transport fault caused by expansion of the transport roller 62 and making the outer diameter of the transport roller large becomes hard to occur.

From the experimental result shown in FIG. 4, the inventor et al. found out that if a material with the absolute value of the solubility parameter difference from wax being 1.0 or more is used, the transport roller scarcely expands. Expansion scarcely occurs in the transport roller made of urethane rubber with the solubility parameter being 10.0 and the absolute value of the solubility parameter difference from wax being 2.0 or the transport roller made of NBR with the solubility parameter being 9.31 and the absolute value of the solubility parameter difference from wax being 1.31.

Then, in the exemplary embodiment, urethane rubber is used as the surface of the transport roller 62 used as the transport roller for coming in contact with the toner image formation side of a sheet and used as the drive roller and the absolute value of the difference between the solubility parameter on the surface of the transport roller and the solubility parameter of the wax contained in the toner is 2.0 more than 1.0, thereby preventing expansion of the transport roller 62, as described above.

In the first exemplary embodiment, urethane rubber is used as the material of the surface of the transport roller 62 and EPDM is used as the material of the surface of the transport roller 64. However, other materials may be used to form the transport roller 62 and the transport roller 64 as long as the solubility parameter of the material of the surface of the transport roller 62 differs from the solubility parameter of the material of the surface of the transport roller 64 and the absolute value of the difference between the solubility parameter of the material of the surface of the transport roller 62 and the solubility parameter of wax is larger than the absolute value of the difference between the solubility parameter of the material of the surface of the transport roller 64 and the solubility parameter of wax.

Table 1 lists modified examples wherein the material of at least either the transport roller 62 or the transport roller 64 in the first exemplary embodiment is changed. In modified example 5, silicone rubber is used as the material of the transport roller 62 and EPDM is used as the material of the transport roller 64. The solubility parameter of silicone is 7.45, which differs from 8.0, the solubility parameter of EPDM. The absolute value of the difference between the solubility parameter of silicone and the solubility parameter of the wax contained in the toner (solubility parameter 8.0) is 0.55, the solubility parameter of EPDM is 8.0, the absolute value of the difference from the solubility parameter of wax is 0, and the absolute value of the difference between the solubility parameter of the material of the surface of the transport roller 62 and the solubility parameter of wax is larger than the absolute value of the difference between the solubility parameter of the material of the surface of the transport roller 64 and the solubility parameter of wax. Thus, in all of modified examples 1 to 35 listed in Table 1, as in the first exemplary embodiment, the solubility parameter of the material of the surface of the transport roller 62 differs from the solubility parameter of the material of the surface of the transport roller 64 and the absolute value of the difference between the solubility parameter of the material of the transport roller 62 and the solubility parameter of wax is larger than the absolute value of the difference between the solubility parameter of the material of the transport roller 64 and the solubility parameter of wax.

TABLE 1

| | | Material of transport roller 64 | | | | | | | |
|---|---|---|---|---|---|---|---|---|---|
| | | EPDA | IR | IIR | BR | SBR | Silicone | CR | NBR |
| Material | EPDA | | — | — | — | — | — | — | — |
| of | IR | Modified | — | — | — | — | — | — | — |
| transport | | Example 1 | | | | | | | |
| roller 62 | IIR | Modified | Modified | — | — | — | — | — | — |
| | | Example 2 | Example 8 | | | | | | |
| | BR | Modified | Modified | Modified | — | — | — | — | — |
| | | Example 3 | Example 9 | Example 15 | | | | | |
| | SBR | Modified | Modified | Modified | Modified | — | — | — | — |
| | | Example 4 | Example 10 | Example 16 | Example 21 | | | | |
| | Silicone | Modified | Modified | Modified | Modified | Modified | — | — | — |
| | | Example 5 | Example 11 | Example 17 | Example 22 | Example 26 | | | |
| | CR | Modified | Modified | Modified | Modified | Modified | Modified | — | — |
| | | Example 6 | Example 12 | Example 18 | Example 23 | Example 27 | Example 30 | | |
| | NBR | Modified | Modified | Modified | Modified | Modified | Modified | Modified | — |
| | | Example 7 | Example 13 | Example 19 | Example 24 | Example 28 | Example 31 | Example 33 | |
| | U | Exemplary | Modified | Modified | Modified | Modified | Modified | Modified | Modified |
| | | Embodiment 1 | Example 14 | Example 20 | Example 25 | Example 29 | Example 32 | Example 34 | Example 35 |

A second exemplary embodiment of transportation device 60 will be discussed.

In the first exemplary embodiment, the transport roller 62 and the transport roller 64 are formed so that the outer diameter increase amount of the transport roller 62 lessens, thereby making a sheet transport fault hard to occur. In the second exemplary embodiment, the speed of a transport roller 62 is set allowing for the outer diameter increase of the transport roller 62, thereby making a sheet transport fault hard to occur. In the first exemplary embodiment, urethane rubber is used as the material of the transport roller 62 and EPDM is used as the material of the transport roller 64; in the second exemplary embodiment, EPDM is used as the surface materials of both the transport roller 62 and a transport roller 64.

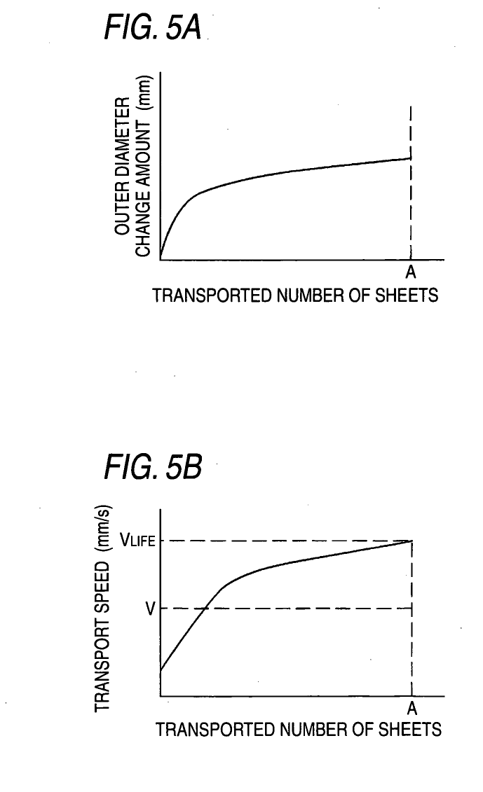

FIG. 5A is a graph to show the relationship between the transported number of sheets formed with toner images using the transport roller 62 made of EPDM used in the second exemplary embodiment and the outer diameter change amount of the transport roller 62, and FIG. 5B is a graph to show the relationship between the transported number of sheets using the transport roller 62 and the sheet transport speed of the transport roller 62. As shown in FIG. 5A, the outer diameter of the transport roller 62 increases rapidly in a state in which the transported number of sheets is small, and then the outer diameter increases moderately as the transported number of sheets increases and approaches the life of the transport roller 62 indicated by A. The transport roller 62 is driven at a given angular velocity by a drive source 74. Thus, the sheet transport speed of the transport roller 62 increases rapidly in a state in which the transported number of sheets is small, and then the sheet transport speed increases moderately as the transported number of sheets approaches the life of the transport roller 62 as with the outer diameter of the transport roller 62, as shown in FIG. 5B.

Then, in the second exemplary embodiment, the setup sheet transport speed of the transport roller 62 at the use start time of the transport roller 62 is set lower than the target sheet transport speed by the speed increment when the transport roller 62 reaches the end of the life. That is, letting the target speed be V and the transport speed when the transport roller 62 reaches the end of the life be V_{life}, the initial speed of the transport roller 62 is set to 2V−V_{life} (subtracting speed increment V_{life}−V from the target speed V). As the initial speed is thus set, although the sheet transport speed of the transport roller 62 is lower than the target speed at the use start time of the transport roller 62, the sheet transport speed of the transport roller 62 approaches the setup speed rapidly with an increase in the number of sheets transported using the transport roller 62, and then the sheet transport speed changes so as to remain in the proximity of the setup speed until the end of the life of the transport roller 62, so that a sheet transport fault becomes hard to occur.

The second exemplary embodiment and the first exemplary embodiment can also be used in combination. For example, if BR involving given outer diameter change although outer diameter change is harder to occur than EPDM (see FIG. 4) is used as the material of the transport roller 62 and EPDM is used as the material of the transport roller 64, the sheet transport speed of the transport roller 62 made of BR may be initialized to 2V−V_{life}.

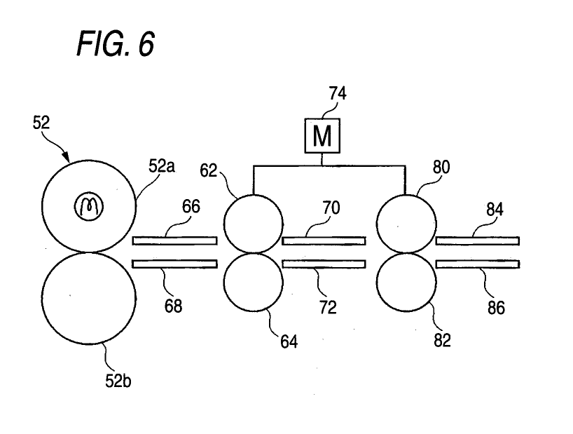

FIG. 6 shows a transportation device 60 according to a third exemplary embodiment of the invention. As compared with the first exemplary embodiment described above, the sheet transported by the transport roller 62 and the transport roller 64 is guided by the upper guide plate 70 and the lower guide plate 72 and is ejected to the ejection tray 32 in the first exemplary embodiment; a transport roller 80 and a transport roller 82 for being pressed against the transport roller 80 from below are provided downstream from an upper guide plate 70 and a lower guide plate 72 in the third exemplary embodiment. An upper guide plate 84 and a lower guide plate 86 are provided downstream from the transport roller 80 and the transport roller 82, and a sheet is guided by the upper guide plate 84 and the lower guide plate 86 and is ejected to an ejection tray 32.

Urethane rubber is used as the material of a surface of a transport roller 62 and EPDM is used as the material of a surface of a transport roller 64 as in the first exemplary embodiment. In the third exemplary embodiment, the transport roller 62 is used as an upstream transport roller provided downstream from a fixing device 52 in the sheet transport direction and upstream from the transport roller 82 in the sheet transport direction. The transport roller 62 is joined to a drive source 74 of a motor, etc., for example, as in the first exemplary embodiment.

The transport roller 80 is used as a downstream transport roller provided downstream from the fixing device 52 in the sheet transport direction, has the same diameter as the transport roller 62, is joined to the drive source 74 like the transport roller 62, and is driven at the same angular velocity as the transport roller 62. EPDM is used as a material of the surface of the transport roller 80. The transport roller 80 needs only to have the surface made of EPDM; for example, the surface of a cored bar is coated with EPDM. The solubility parameter of EPDM is 8.0 as described above.

EPDM is used as a material of the surface of the transport roller 82. The transport roller 82 needs only to have the surface made of EPDM; for example, the surface of a cored bar is coated with EPDM. The transport roller 82 abuts the transport roller 80 and is driven by the transport roller 80 for transporting a sheet.

As described above, in the third exemplary embodiment, urethane rubber is used as the material of the surface of the transport roller 62 and EPDM is used as the surface of the transport roller 80, thereby making the solubility parameter on the surface of the transport roller 62 different from the solubility parameter on the surface of the transport roller 80 and making it possible to use the transport roller having the optimum characteristic in response to the position of each transport roller. That is, urethane rubber having the solubility parameter distant from that of wax and making wax hard to penetrate is used as the material of the surface of the transport roller 62 placed at a position where the transport roller 62 is nearer to the fixing device 52 than the transport roller 80 and wax contained in toner image is easier to penetrate. On the other hand, the transport roller 80 is placed at a position where wax is hard to penetrate as compared with the transport roller 62. Then, EPDM having a high friction coefficient is used as the material of the surface of the transport roller 80. The reason why wax is easy to penetrate into the transport roller 62 as compared with the transport roller 80 is that the toner heated and softened by the fixing device 52 does not sufficiently harden when it comes in contact with the transport roller 62.

Urethane rubber is used as the material of the surface of the transport roller 62 and EPDM is used as the surface of the transport roller 80, whereby the absolute value of the difference between the solubility parameter of the material used as the surface of the transport roller 62 and the solubility parameter of wax is made larger than the absolute value of the difference between the solubility parameter of the material used as the surface of the transport roller 80 and the solubility parameter of wax. That is, letting the solubility parameter on the surface of the transport roller 62 be SP₆₂, the solubility parameter on the surface of the transport roller 80 be SP₈₀, and the solubility parameter of wax be SP_{WAX},

|SP_{WAX}−SP₆₂|>|SP_{WAX}−SP₈₀|

Thus, as compared with the transport roller 80, a material hard to expand can be used as the surface of the transport roller 62 and a sheet transport fault caused by expansion of the transport roller 62 and making the outer diameter of the transport roller large becomes hard to occur.

In the third exemplary embodiment, urethane rubber is used as the material of the surface of the transport roller 62 positioned upstream and EPDM is used as the material of the surface of the transport roller 80 positioned downstream. However, other materials may be used to form the transport roller 62 and the transport roller 80 as long as the solubility parameter of the material of the surface of the transport roller 62 differs from the solubility parameter of the material of the surface of the transport roller 80 and the absolute value of the difference between the solubility parameter of the material of the surface of the transport roller 62 and the solubility parameter of wax is larger than the absolute value of the difference between the solubility parameter of the material of the surface of the transport roller 80 and the solubility parameter of wax.

Table 2 lists modified examples wherein the material of at least either the transport roller 62 or the transport roller 80 in the third exemplary embodiment is changed. In modified example 5, silicone rubber is used as the material of the transport roller 62 and EPDM is used as the material of the transport roller 80. The solubility parameter of silicone is 7.45, which differs from 8.0, the solubility parameter of EPDM. The absolute value of the difference between the solubility parameter of silicone and the solubility parameter of the wax contained in the toner (solubility parameter 8.0) is 0.55, the solubility parameter of EPDM is 8.0, the absolute value of the difference from the solubility parameter of wax is 0, and the absolute value of the difference between the solubility parameter of the material of the surface of the transport roller 62 and the solubility parameter of wax is larger than the absolute value of the difference between the solubility parameter of the material of the surface of the transport roller 80 and the solubility parameter of wax. Thus, in all of modified examples 1 to 35 listed in Table 2, as in the third exemplary embodiment, the solubility parameter of the material of the surface of the transport roller 62 differs from the solubility parameter of the material of the surface of the transport roller 80 and the absolute value of the difference between the solubility parameter of the material of the transport roller 62 and the solubility parameter of wax is larger than the absolute value of the difference between the solubility parameter of the material of the transport roller 80 and the solubility parameter of wax.

TABLE 2

| | | Material of transport roller 80 | | | | | | | |
|---|---|---|---|---|---|---|---|---|---|
| | | EPDA | IR | IIR | BR | SBR | Silicone | CR | NBR |
| Material | EPDA | | — | — | — | — | — | — | — |
| of | IR | Modified | — | — | — | — | — | — | — |
| transport | | Example 1 | | | | | | | |
| roller 62 | IIR | Modified | Modified | — | — | — | — | — | — |
| | | Example 2 | Example 8 | | | | | | |
| | BR | Modified | Modified | Modified | — | — | — | — | — |
| | | Example 3 | Example 9 | Example 15 | | | | | |
| | SBR | Modified | Modified | Modified | Modified | — | — | — | — |
| | | Example 4 | Example 10 | Example 16 | Example 21 | | | | |
| | Silicone | Modified | Modified | Modified | Modified | Modified | — | — | — |
| | | Example 5 | Example 11 | Example 17 | Example 22 | Example 26 | | | |
| | CR | Modified | Modified | Modified | Modified | Modified | Modified | — | — |
| | | Example 6 | Example 12 | Example 18 | Example 23 | Example 27 | Example 30 | | |
| | NBR | Modified | Modified | Modified | Modified | Modified | Modified | Modified | — |
| | | Example 7 | Example 13 | Example 19 | Example 24 | Example 28 | Example 31 | Example 33 | |
| | U | Exemplary | Modified | Modified | Modified | Modified | Modified | Modified | Modified |
| | | Embodiment 3 | Example 14 | Example 20 | Example 25 | Example 29 | Example 32 | Example 34 | Example 35 |

A fourth exemplary embodiment of transportation device 60 will be discussed.

In the third exemplary embodiment, the transport roller 62 and the transport roller 80 are formed so that the outer diameter increase amounts of the transport roller 62 and the transport roller 80 lessen, thereby making a sheet transport fault hard to occur. In the fourth exemplary embodiment, the speed of a transport roller 62 and the speed of a transport roller 80 are set allowing for the outer diameter increase of the transport roller 62 and the transport roller 80, thereby making a sheet transport fault hard to occur. In the third exemplary embodiment, urethane rubber is used as the material of the transport roller 62 and EPDM is used as the material of the transport roller 80; in the fourth exemplary embodiment, EPDM is used as the materials of both the transport roller 62 and the transport roller 80.

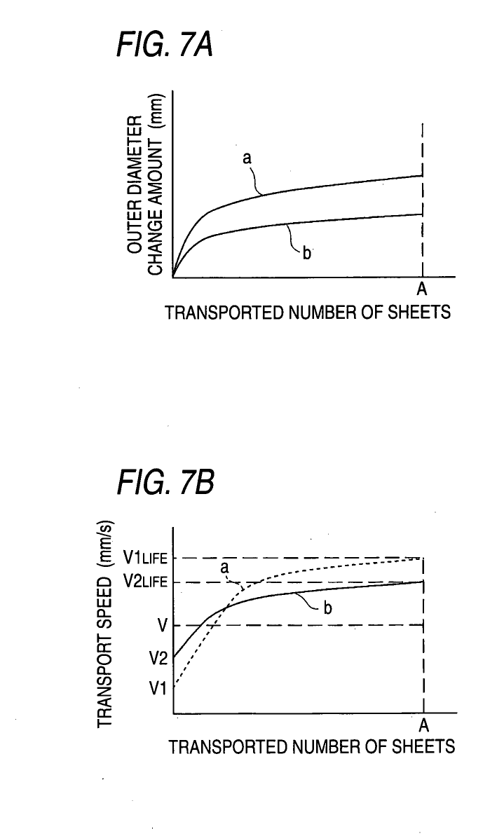

FIG. 7A is a graph to show the relationship between the numbers of sheets transported using the transport roller 62 and the transport roller 80 in a placement state in image formation apparatus 10 and the outer diameter change amounts of the transport rolls; curve a indicates the relationship applied to the transport roller 62 and curve b indicates the relationship applied to the transport roller 80. FIG. 7B is a graph to show the relationship between the numbers of sheets transported using the transport roller 62 and the transport roller 80 and the sheet transport speed of the transport roller 62 and that of the transport roller 80; curve a indicates the relationship applied to the transport roller 62 and curve b indicates the relationship applied to the transport roller 80.

As shown in FIG. 7A, the outer diameters of the transport roller 62 and the transport roller 80 increase rapidly in a state in which the transported number of sheets is small, and then the outer diameter increases moderately as the transported number of sheets increases and approaches the life of the transport roller 62 indicated by A as in the second exemplary embodiment. The reason why the outer diameter increase amount of the transport roller 62 is larger than that of the transport roller 80 although EPDM is used as the materials of both the transport roller 62 and the transport roller 80 is that the wax contained in the toner image formed on a sheet is easier to penetrate because the transport roller 62 is positioned upstream from the transport roller 80 and is placed just downstream from the fixing device 52 as described above.

The transport roller 62 and the transport roller 80 are driven at a given angular velocity by a drive source 74. Thus, the sheet transport speed of the transport roller 62 and that of the transport roller 80 increase rapidly in a state in which the transported number of sheets is small, and then the sheet transport speed increases moderately as the transported number of sheets approaches the life of the transport roller 62 as with the outer diameter, as shown in FIG. 7B. The sheet transport speed of the transport roller 62 when the transport roller reaches the end of the life becomes V1_{life} and the sheet transport speed of the transport roller 80 when the transport roller reaches the end of the life becomes V2_{life}. The reason why V1_{life} is higher than V2_{life} is that the outer diameter increase amount of the transport roller 62 is larger than that of the transport roller 80 as described above.

In the fourth exemplary embodiment, letting the target speed be V, initialized sheet transport speed V1 of the transport roller 62 is set to 2V−V1_{life} as in the second exemplary embodiment. Initialized sheet transport speed V2 of the transport roller 80 is set to 2V−V2_{life}. As the initial speed of the transport roller 62 and that of the transport roller 80 are thus set, although the sheet transport speed of the transport roller 62 and that of the transport roller 80 are lower than the target speed at the use start time of the transport rolls, the sheet transport speed of each transport roller approaches the setup speed rapidly with an increase in the number of sheets transported using each transport roller, and then the sheet transport speed changes so as to remain in the proximity of the setup speed until the end of the life of the transport roller 62, so that a sheet transport fault becomes hard to occur.

As described above, V1_{life} is a value larger than V2_{life} and in the exemplary embodiment, the initialized sheet transport speed V1 of the transport roller 62 positioned upstream and placed near the fixing device 52 is set lower than the initialized sheet transport speed V2 of the transport roller 80. The initialized sheet transport speed V1 of the transport roller 62 positioned nearer to the fixing device 52 and easier increased in the sheet transport speed is thus set lower than the setup sheet transport speed V2 of the transport roller 80, so that the sheet transport speed difference between the transport roller 62 and the transport roller 80 lessens and a sheet transport fault can be made hard to occur. In the exemplary embodiment, the target speed of the transport roller 62 and that of the transport roller 80 are set both to V, but need not necessarily be the same and may be set to different values.

As described above, the invention can be applied to an image formation apparatus of a copier, a facsimile, a printer, etc., having a transportation device for transporting a recording medium such as a sheet on which an image is formed in toner containing a low-melting-point material of wax, etc., for example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image formation apparatus comprising:
a toner image formation section that forms a toner image on a recording medium;
a fixing device that fixes the toner image;
a first roller provided downstream from the fixing device in a transport direction of the recording medium, the first roller coming in contact with a first side of the recording medium and transporting the recording medium; and
a second roller abutting the first roller, the second roller coming in contact with a second side of the recording medium opposite to the first side and transporting the recording medium,
wherein a solubility parameter on a surface of the first roller is different from a solubility parameter on a surface of the second roller.

2. The image formation apparatus according to claim 1, wherein the toner image is formed on the first side of the recording medium.

3. The image formation apparatus according to claim 2, wherein an absolute value of a difference between the solubility parameter of the first roller and a solubility parameter of a low-melting-point material contained in a toner of the toner image is larger than an absolute value of a difference between the solubility parameter of the second roller and the solubility parameter of the low-melting-point material.

4. The image formation apparatus according to claim 3, wherein the absolute value of the difference between the solubility parameter of the first roller and the solubility parameter of the low-melting-point material is 1.0 or more.

5. An image formation apparatus comprising:
a toner image formation section that forms a toner image on a recording medium;
a fixing device that fixes the toner image;
a first roller provided downstream from the fixing device in a transport direction of the recording medium, the first roller being subjected to drive transmission from a drive source to transport the recording medium; and
a second roller abutting the first roller, the second roller being driven by the first roller and transporting the recording medium,
wherein a solubility parameter on a surface of the first roller is different from a solubility parameter on a surface of the second roller.

6. The image formation apparatus according to claim 5, wherein the first roller comes in contact with a side of the recording medium on which the toner image has been formed.

7. The image formation apparatus according to claim 6, wherein an absolute value of a difference between the solubility parameter of the first roller and a solubility parameter of a low-melting-point material contained in a toner of the toner image is larger than an absolute value of a difference between the solubility parameter of the second roller and the solubility parameter of the low-melting-point material.

8. The image formation apparatus according to claim 7, wherein the absolute value of the difference between the solubility parameter of the first roller and the solubility parameter of the low-melting-point material is 1.0 or more.

9. An image formation apparatus comprising:
a toner image formation section that forms a toner image on a recording medium;
a fixing device that fixes the toner image; and
a roller provided downstream from the fixing device in a transport direction of the recording medium, the roller transporting the recording medium and having a transport speed lower than a target transport speed.

10. An image formation apparatus comprising:
a toner image formation section that forms a toner image on a recording medium;
a fixing device that fixes the toner image; and
a roller provided downstream from the fixing device in a transport direction of the recording medium, the roller coming in contact with a side of the recording medium on which the toner image has been formed and transporting the recording medium,
wherein an absolute value of a difference between a solubility parameter on a surface of the roller and a solubility parameter of a low-melting-point material contained in a toner of the toner image is 1.0 or more.

11. An image formation apparatus comprising:
a toner image formation section that forms a toner image on a recording medium;
a fixing device that fixes the toner image;
a downstream roller transporting the recording medium and being provided downstream from the fixing device in a transport direction of the recording medium; and
an upstream roller transporting the recording medium and being positioned downstream from the fixing device and upstream from the downstream roller in the transport direction,
wherein a solubility parameter on a surface of the upstream roller is different from a solubility parameter on a surface of the downstream roller.

12. The image formation apparatus according to claim 11, wherein both upstream roller and downstream roller come in contact with a side of the recording medium on which the toner image has been formed, and an absolute value of a difference between the solubility parameter of the upstream roller and a solubility parameter of a low-melting-point material contained in a toner of the toner image is larger than an absolute value of a difference between the solubility parameter of the downstream roller and the solubility parameter of the low-melting-point material.

13. An image formation apparatus comprising:
a toner image formation section that forms a toner image on a recording medium;
a fixing device that fixes the toner image;
a downstream roller transporting the recording medium and being provided downstream from the fixing device in a transport direction of the recording medium; and
an upstream roller transporting the recording medium and being positioned downstream from the fixing device and upstream from the downstream roller in the transport direction,
a difference between a target transport speed of the recording medium and a setup transport speed of the upstream roller is larger than a difference between the target transport speed and a setup transport speed of the downstream roller.

14. An image formation apparatus comprising:
a toner image formation section that forms a toner image on a recording medium;
a fixing device that fixes the toner image;
a first roller provided downstream from the fixing device in a transport direction of the recording medium, the first roller coming in contact with a first side of the recording medium and transporting the recording medium, and the first roller having a transport speed lower than a target transport speed of the recording medium; and
a second roller abutting the first roller, the second roller coming in contact with a second side of the recording medium opposite to the first side and transporting the recording medium,
wherein a solubility parameter on a surface of the first roller is different from a solubility parameter on a surface of the second roller.

15. The image formation apparatus according to claim 14, wherein the toner image is formed on the first side of the recording medium.
